(19) United States
(12) Patent Application Publication
(10) Pub. No.: US 2006/0196867 A1
(43) Pub. Date: Sep. 7, 2006

(54) Plate type of solid-oil melting heater

(75) Inventors: Minoru Hondo, Shinagawa-ku (JP); Hideki Watanobe, Shinagawa-ku (JP)

Correspondence Address: COHEN, PONTANI, LIEBERMAN & PAVANE, 551 FIFTH AVENUE, SUITE 1210, NEW YORK, NY, 10176, US

(73) Assignee: Tanico Corporation, Tokyo (JP)

(21) Appl. No.: 11/337,635

(22) Filed: Jan. 23, 2006

Related U.S. Application Data
(63) Continuation of application No. PCT/JP03/14025, filed on Oct. 31, 2003.

(30) Foreign Application Priority Data
Aug. 26, 2003 (JP) 2003-301685

(51) Int. Cl. F27D 11/00

(52) U.S. Cl. 219/437

(57) ABSTRACT

Disclosed is a plate type of heating device for melting solid oils comprising a sheathed heater, a plate-like metal covering for enclosing the major part of the sheathed heater in thermal conducting relation with the metal covering, an external cladding body joining with the opposite ends of the sheathed heater, a handle integrally connected to the external cladding body and a connector for connecting the sheathed heater to an electric power source through the external cladding body.

### RELATED APPLICATION

This application is a U.S. Continuation Application of International Application PCT/JP2003/014025 filed Oct. 31, 2003.

### FIELD OF THE INVENTION

The present invention relates to a solid-oil melting heater, particularly an immersion heating device for melting solid-oils.

### BACKGROUND OF THE INVENTION

Recently a variety of fries have been served with popularity in the food service industry including fast food shops, and different kinds of cooking oil are used in cooking food in hot oil. Oils of animals and plants are transported and stored in the state of being solid. Such solid oils, therefore, needs to be melted just before using.

Usually these solid oils such as shortening oil or lard are melted by putting a can of solid oil on the hot plate or by putting in the can of solid oil an immersion heating device whose surface temperature is raised up to 600° C. or higher. Almost all immersion heating devices have a sheathed heater extending down from the handle of the device, and terminated with an associated plug. The sheathed heater generally looks like a serpentine pattern laid in a flat and rectangular plane. The sheathed heater is exposed or not covered, and is connected to the plug.

Immersion heating devices with their sheathed heater embedded in cast metal are used in heating different objects. Such cast metal type of immersion heating devices are disclosed among others, in Utility Model Application Laid-Open No. S 63-194495, Utility Model Application Laid-Open No. H 5-66892 or Patent Application Laid-Open No. H10-302941.

Irrespective of whether the solid oil is melted by putting a can of solid oil on the hot plate or by putting an immersion heating device in a can of solid oil there is a fear that the oil temperature rises to the extent that a fire is caught before being aware of the danger. Also, disadvantageously when the solid oil is melted by using an immersion heating device, the melting starts from the surrounding of the heater, gradually expanding apart from the heater. Thus, the melting cannot be even, and it takes a long time to completely melt the solid oil. Still disadvantageously the elevated temperature is apt to cause deterioration of the oil.

The surface temperature of the conventional immersion heating device is apt to rise so high that there is a fear of catching a fire, and the sheathed heater is easily deformed or broken because it is exposed, and therefore, the sheathed heater is liable to snap or the electric leak often appears.

The conventional cast metal type of immersion heating device whose sheathed heater is not exposed is advantageously free of the breakage or leak, which would be the matter of concern with the conventional immersion heating device having its sheathed heater exposed. Such cast metal type of immersion heating devices appear to be advantageously used in melting solid oils, but they are not designed for the purpose of melting solid oils, not paying any consideration to: excessive temperature rise high enough to catch a fire; even melt of solid oil; and the shortening of the time involved in melting solid oil.

In view of the above, one object of the present invention is to provide a heating device which is free of the defects as mentioned above in melting solid oil.

### DISCLOSURE OF THE INVENTION

A plate type of heating device for melting solid oils according to the present invention comprises a sheathed heater, a plate-like metal covering for enclosing the major part of the sheathed heater in thermal conducting relation with the metal covering, an external cladding body joining with the opposite ends of the sheathed heater, a handle integrally connected to the external cladding body and a connector for connecting the sheathed heater to an electric power source through the external cladding body.

According to one embodiment of the present invention the major part of the sheathed heater is serpentine, and the plate-like metal is a cast aluminum plate having the major part of the sheathed heater embedded therein.

According to another embodiment of the present invention the cast aluminum plate has a plurality of grooves or fins formed on its outer surface.

According to still another embodiment of the present invention the major part of the sheathed heater is serpentine and the cast aluminum plate comprises two aluminum plates to sandwich the major part of the sheathed heater therebetween.

According to still another embodiment of the present invention the aluminum plates have a plurality of through holes or slots made therein.

According to yet still another embodiment of the present invention the external cladding body is equipped with a temperature control.

According to yet still another embodiment of the present invention the external cladding body is equipped with a thermoprotector.

According to yet still another embodiment of the present invention the external cladding body has a hook to hang the heating device from the upper edge of a can of solid oil.

Embodiments of the present invention will be described below with reference to the accompanying drawings:

### BRIEF DESCRIPTION OF THE DRAWINGS

FIG. 1 is a front view of a plate type of solid oil melting heater according to one embodiment of the present invention;

FIG. 2 is a side view of the plate type of solid oil melting heater of FIG. 1;

FIG. 3 is a cross section of the plate type of solid oil taken along the line A-A in FIG. 1;

FIG. 4A shows how some parts are arranged and electrically connected to each other in the external cladding body of the plate-like heating device;

FIG. 4B shows an electric circuit in the plate-like heating device;

FIGS. 5A and 5B illustrate how the plate-like heating device can be used;

FIG. 6 is a front view of a plate type of solid oil melting heater according to another embodiment of the present invention; and

FIG. 7 is a side view of the plate type of solid oil melting heater of FIG. 6.

### PREFERRED EMBODIMENTS OF THE PRESENT INVENTION

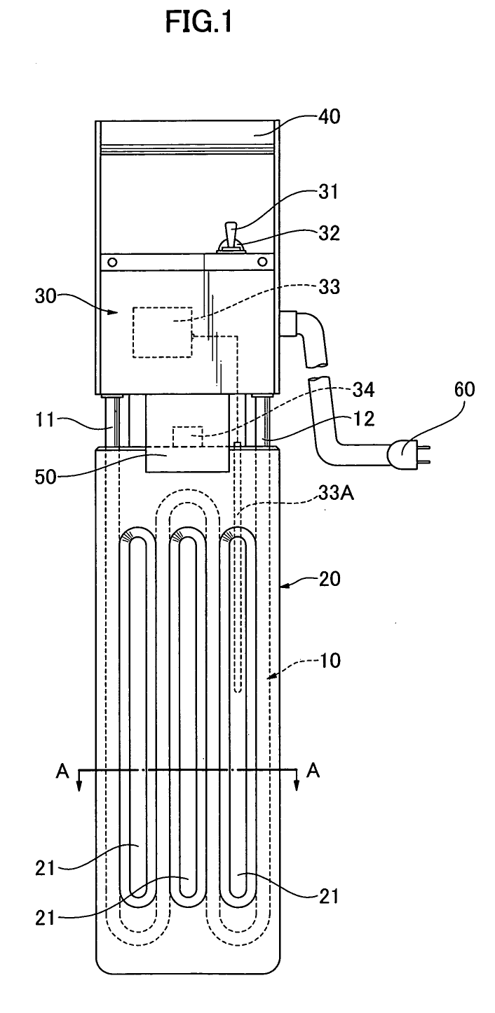

Referring to FIGS. 1, 2 and 3, a plate type of solid oil melting heater according to one embodiment of the present invention comprises a serpentine sheathed heater 10 whose major part extends over as large an area as required for evenly heating and melting the solid oil, a cast aluminum plate 20 having the serpentine sheathed heater 10 embedded therein, an external cladding body 30 joining with the opposite ends 11 and 12 of the sheathed heater 10, a handle 40 having its opposite legs fixed to the opposite sides of the external cladding body 30, a hook 50 fixed to the lower part of the front side of the external cladding body 30, and an electric cord 60 extending from one side of the external cladding body 30.

As best seen from FIG. 3, the cast aluminum plate 20 has three grooves 21 made on either major surface, thereby reducing the weight of the whole heating device and increasing the heating surface area. Alternatively fins may be formed on the opposite major surfaces of the cast aluminum plate.

The external cladding body 30 has an electric switch 31 and an indicator lamp 32 both mounted thereon, and it has a temperature control 33 built inside, also. The temperature control 33 has its beat-sensitive detector 33A built in the thickness of the cast aluminum plate 20, and wired to the control body. The temperature control 33 detects and controls the instantaneous temperature in the thickness of the cast aluminum plate 20 (for example, at a given point 160 mm deep from the plate surface). A variety of temperature controls commercially available can be used, and a liquid-expansion type of temperature control may be advantageously used.

The external cladding body 30 has a bimetal thermoprotector 34 fixed to its lower part. The bimetal thermoprotector 34 is sensitive to the temperature of the cast aluminum plate 20 for controlling the surface temperature. A thermal fuse may be used as an alternative for the bimetal thermal switch.

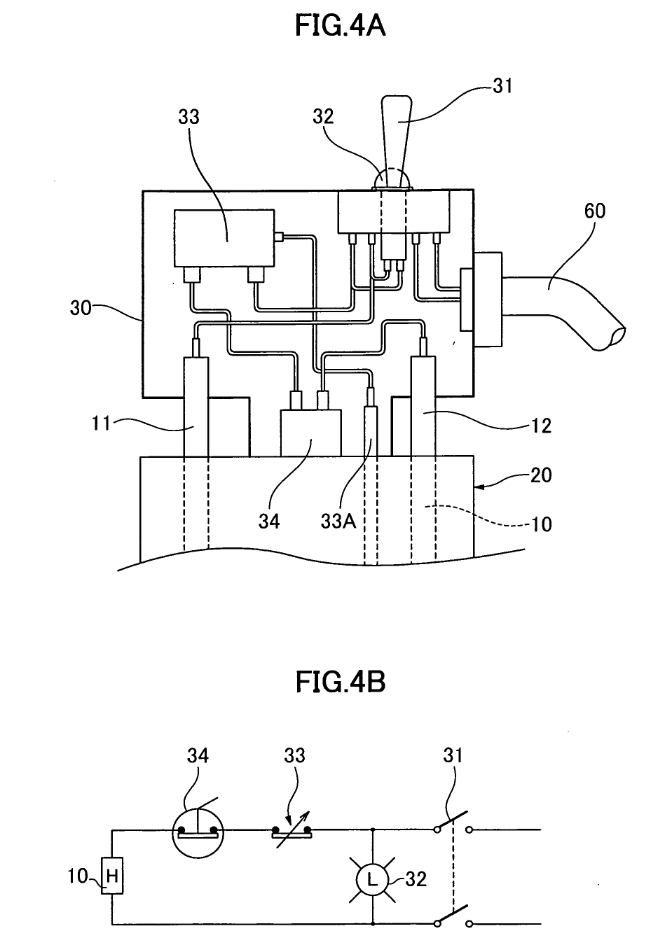

FIG. 4A shows arrangement of some parts built in the external cladding body. Specifically the drawing shows how an electric power switch 31, an electric power lamp 32, a temperature control 33 and an associated bimetal thermal switch 34, the opposite ends 11 and 12 of the sheathed heater 10 and an electric cord 60 are arranged and electrically connected to each other. FIG. 4B is a wiring diagram of these parts. As seen from FIGS. 4A and 4B, one end 11 of the sheathed heater 10 is connected to one terminal of the lamp 32 and one terminal of the switch 31 whereas the other end 12 of the sheathed heater 10 is connected both to the other end of the lamp 32 and the other terminal of the switch 31 through the bimetal thermo switch 34 and the temperature control 33. One conductor of the electric cord 60 is connected to one of the throwing-in contacts of the switch 31 and the other conductor is connected to the other throwing-in contact of the switch 31. One terminal of the switch 31 is connected to one terminal of the lamp 32 whereas the other terminal of the switch 31 is connected to the other terminal of the lamp 32.

The heating device is so constructed as to have the following particulars: the ignition temperature of a solid oil which the heating device is applied to is about 420° C.; the surface temperature can rise up to about 380° C.; the temperature control 33 is sensitive to the temperature 160° C. or higher for performing a required control; the bimetal thermo switch is used as a backup for the danger of the failure of the temperature control, and it is responsive to 200° C. for making the temperature control 33 turn off, thereby providing a double security. The bimetal thermo switch is of the hand-operated type which cannot be reset without using the user's hand.

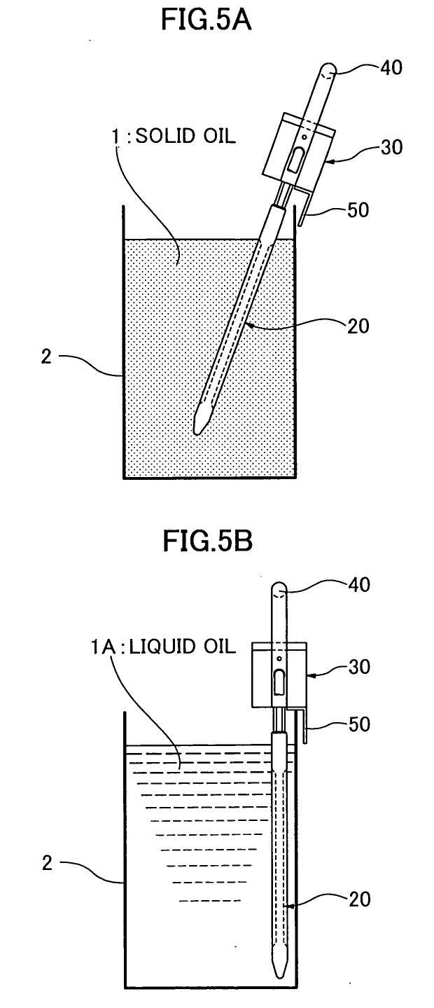

FIGS. 5A and 5B show how the plat type of solid oil melting heater can be used in melting solid oil. As seen from FIG. 5A, first, the lid is removed from a can 2 containing solid oil 1. The plug of the electric cord 60 is inserted in an outlet (not shown), and the electric power switch 31 turns on. The sheathed heater 10 is energized, and the plate-like cast aluminum body 20 reaches an appropriate temperature on its surface. Then, the hot body 20 is put in the can of solid oil to be inclined in the solid oil. Usually the solid edible oil starts melting around 70° C., and the heated cast aluminum body 20 gradually immerse itself into the solid oil until the edge of the can catches the heating device by the hook 50.

In this position the cast aluminum body 20 raises its surface temperature, and accordingly the solid oil 1 in the can expands its melting zone. The cast aluminum body 20 gradually changes its posture automatically by its self-weight toward the upright position along the vertical side of the can 2. Finally the cast aluminum body 20 hangs down from the upper edge of the can 2. When the solid oil is completely melted at the temperature of about 120° C., the temperature of the cast aluminum body 20 is around 150° C.

When the solid oil 1 in the can 2 becomes liquid oil 1A at the termination of the melting, the electric power switch 31 turns off, and then, the heating device is removed from the can 2.

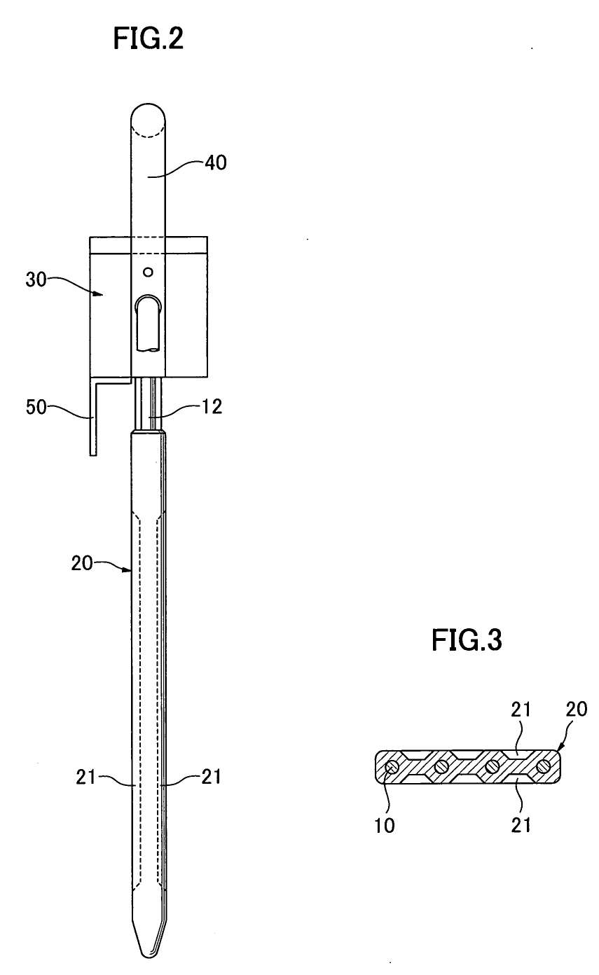

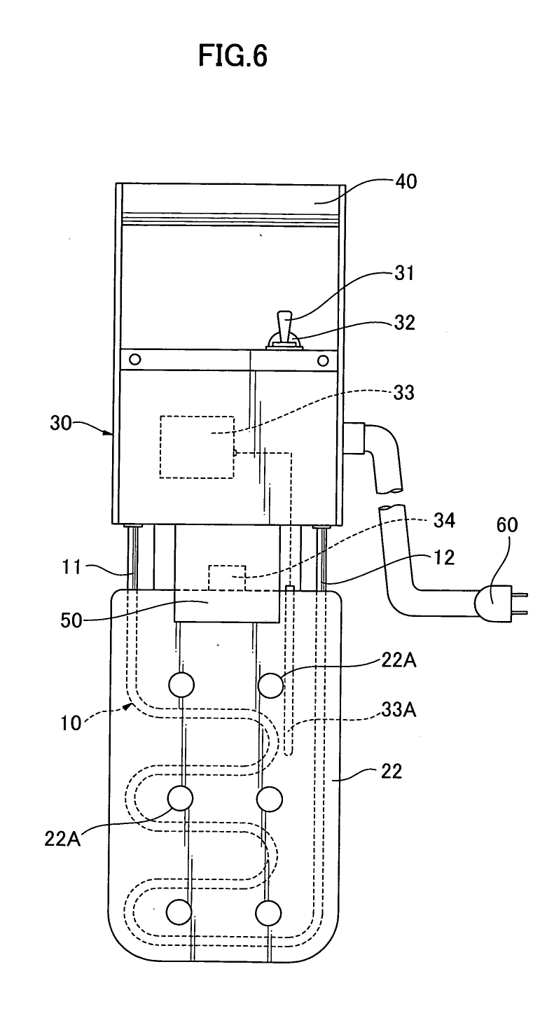

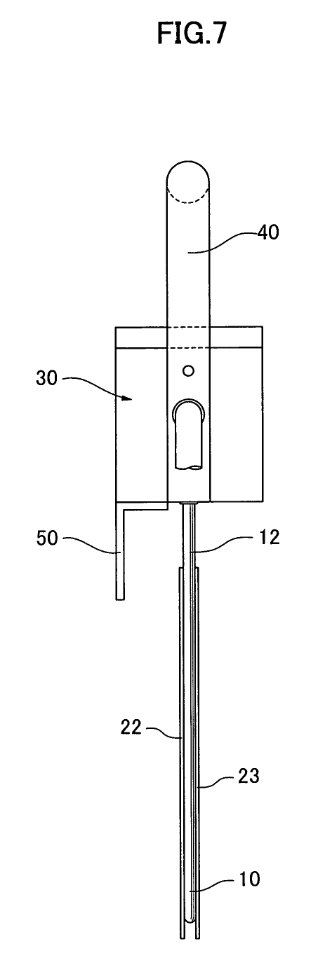

FIG. 6 is a front view of a plate type of heating device for melting a solid oil according to another embodiment of the present invention, and FIG. 7 is a side view of the heating device. The heating device described above uses a cast aluminum body having a sheathed heater 10 buried therein. In contrast the heating device of FIGS. 6 and 7 has its sheathed heater sandwiched between two aluminum plates. The other parts of the heating device are same as used in the heating device of FIGS. 1 and 2, and are indicated by same reference numerals as used in FIGS. 1 and 2. The following description, therefore, is directed only to the structure which is different from the cast aluminum heating device.

As seen from FIGS. 6 and 7, the major serpentine part of the sheathed heater 10 is sandwiched between the opposite aluminum plates 22 and 23. These aluminum plates can be fixedly stacked to the major serpentine part of the sheathed heater 10 in any conventional way, provided that the aluminum plates and the major serpentine part of the sheathed heater 10 are kept in the state of being in good thermal conduction. Partly because of reducing the weight of the whole heating device as much as possible and partly because of preventing the oil from staying in the plate-like heater the aluminum plates 22 and 23 may advantageously have a plurality of through holes or slots 22A.

The cast aluminum body or aluminum plates to sandwich a sheathed heater can be made of any metal other than aluminum, provided that such metal is good in thermal conduction.

### INDUSTRIAL UTILITY

The heating device according to the present invention can have a relatively large hot surface, thus increasing the melting speed, and accordingly shortening the time involved in melting solid oil.

The major serpentine part of the sheathed heater provides an extensive, evenly hot flat area, thereby permitting the solid oil to be evenly heated and melted, and preventing any defects which would be caused by the uneven melting of the solid oil.

The sheathed heater is fully protected, and therefore, it is free of any breakage or leak which otherwise, would be caused if the sheathed heater remained exposed.

The thermal control assures that the heating temperature is satisfactorily controlled, eliminating the possibility of catching a fire, assuring the security and at the same time, preventing the solid oil against deterioration while being melted. Use of the thermal protector as a backup of the temperature control assures the security against the abnormal rise of temperature, which would be caused by the failure of the temperature control or by heating an empty can. The double security is assured for an abnormal condition or danger.

As is apparent from the above, solid oil can be melted quickly in good condition, and the shape of the heating device facilitates cleaning. The heating device can be used safely without any fear of catching a fire. All of these advantages make the heating device according to the present invention most appropriate for use in the food service industry where a lot of edible solid oil is used.

1. A plate type of heating device for melting solid oils comprising a sheathed heater, a plate-like metal covering for enclosing the major part of the sheathed heater in thermal conducting relation with the metal covering, an external cladding body joining with the opposite ends of the sheathed heater, a handle integrally connected to the external cladding body and a connector for connecting the sheathed heater to an electric power source through the external cladding body.

2. A plate type of heating device for melting solid oils according to claim 1 wherein the major part of the sheathed heater is serpentine, and the plate-like metal is a cast aluminum plate having the major part of the sheathed heater embedded therein.

3. A plate type of heating device for melting solid oils according to claim 2 wherein the cast aluminum plate has a plurality of grooves or fins formed on its outer surface.

4. A plate type of heating device for melting solid oils according to claim 1 wherein the major part of the sheathed heater is serpentine and the cast aluminum plate comprises two aluminum plates to sandwich the major part of the sheathed heater therebetween.

5. A plate type of heating device for melting solid oils according to claim 4 wherein the aluminum plates have a plurality of through holes or slots made therein.

6. A plate type of heating device for melting solid oils according to claim 1 wherein the external cladding body is equipped with a temperature control.

7. A plate type of heating device for melting solid oils according to claim 1 wherein the external cladding body is equipped with a thermoprotector.

8. A plate type of heating device for melting solid oils according to claim 1 wherein the external cladding body has a hook to hang the heating device from the upper edge of a can of solid oil.
